(19) United States
(12) Patent Application Publication
(10) Pub. No.: US 2003/0225748 A1
(43) Pub. Date: Dec. 4, 2003

(54) Project knowledge management

(76) Inventor: Tilmann Haeberle, Wiesloch (DE)

Correspondence Address: MARK D. KIRKLAND, Fish & Richardson P.C., 60 South Sixth Street, 3300 Dain Rauscher Plaza, Minneapolis, MN, 55402, US

(21) Appl. No.: 10/159,541

(22) Filed: May 29, 2002

(51) Int. Cl. G06F 17/30; G06F 7/00

(52) U.S. Cl. 707/3

(57) ABSTRACT

A project workforce management system defines project tasks, project positions, and assigns personnel to the project positions. During the project and following project completion, data is collected regarding the success of project tasks, project positions, and personnel assignments. The project manager reviews how similar opportunities have been handled in the past, and may select to re-use project templates, tasks, positions and personnel assignments that proved successful in similar opportunities.

### TECHNICAL FIELD

This invention relates to project management systems and methods, and more particularly to a software-based system and method for project and knowledge management.

### BACKGROUND

Good project management is an important factor to the success of a project. A project may be thought of as a collection of activities and tasks designed to achieve a specific goal of the organization, with specific performance or quality requirements while meeting any subject time and cost constraints. Project management refers to managing the activities that lead to the successful completion of a project. Project management focuses on finite deadlines and objectives. A number of tools may be used to assist with project management and assessment.

Project management may be used when planning of personnel resources and check capacities is desired. The project may be linked to the objects in a professional services life cycle and may accompany the objects from the opportunity over quotation, contract, time and expense (T&E) recording, billing, period-end-activities until the final reporting. Naturally the project gets even more detailed when moving through this cycle.

A project may arise as an opportunity or a request for quotation (inquiry) sent by a potential customer. When the opportunity or request arrives, a decision has to take place by the manager whether the opportunity should be pursued or a quotation be submitted. Even at this early stage, it is important to check whether the company has the necessary capacity and resources with the required skills and qualifications available at the requested time.

For any given project, several project tasks should be defined. Project tasks describe the activities and phases that have to be performed in the project such as writing of blueprints, customizing, testing etc. and can be arranged hierarchically.

What is needed is a system that allows for experience from past projects to be used to in creating a current project. Knowledge on projects in the past may be an important asset. Using past knowledge, project managers can repeat successful methodologies, avoid mistakes, eliminate risks, and do more accurate quotations for new, similar projects. By employing knowledge management, the knowledge can be kept within a firm even with high staff turnover ranges.

### SUMMARY

A project workforce management system defines project tasks, project positions, and assigns personnel to the project positions. During the project and following project completion, data is collected regarding the success of project tasks, project positions, and personnel assignments. The project manager reviews how similar opportunities have been handled in the past, and may select to re-use project templates, tasks, positions and personnel assignments that proved successful in similar opportunities.

### DESCRIPTION OF DRAWINGS

These and other features and advantages of the invention will become more apparent upon reading the following detailed description and upon reference to the accompanying drawings.

FIG. 1 illustrates the overall structure of a project management system.

FIG. 2 illustrates a process for generating a project in a project management system.

FIG. 3 illustrates a process for incorporating successful project attributes in a project management system.

FIG. 4 illustrates a process for collecting and storing effectiveness data in a project management system.

### DETAILED DESCRIPTION

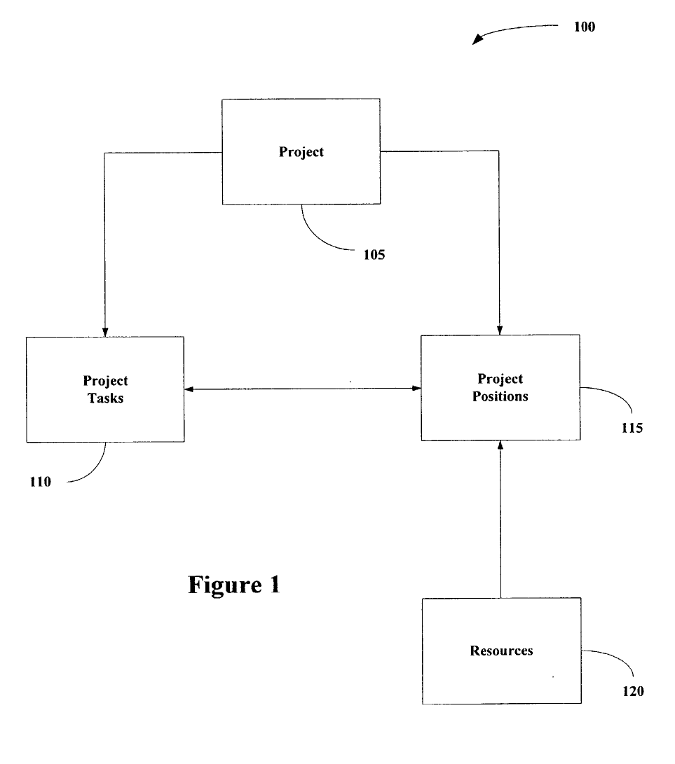

FIG. 1 illustrates the overall structure of project management system 100 showing the relationship between a project 105, project tasks 110, project positions 115, and resources 120. The project 100 is a strategy to achieve a defined goal of an organization. The project 100 may be divided into a series of project tasks 110 and/or a series of project positions 115.

The project tasks 110 define activities and phases to be performed in the project 105. For example, for a construction project examples of project tasks 110 may include preparing blue prints, obtaining the proper permits, preparing the foundation, ordering the lumber, hiring sub-contractors, etc. The project tasks 110 describe operational activities or phases in the project 105 that should be performed like analysis, business blueprint, implementation, and documentation. The project tasks 110 describe qualification requirements and time demand: To be able, e.g., to write a business blueprint document it is necessary to have attended a specific training session and to be available in the first weeks of September. Project tasks 110 have a hierarchical structure, i.e. tasks can be grouped or split up. Sometimes the refinement and split of tasks into several subtasks occurs at a later time in the life cycle of the project 110.

The project positions 115 define project roles by job title. For the same construction example, project positions 115 may include architect, foreman, electrician, mason, supervisor, etc. The project positions 115 may include qualifications and requirements for each project position 115. Thus, a project position 115 may require availability (such as during the month of July) and certain certifications (such as certification for high voltage installations, professional licenses). The project positions 115 represent roles in the project 105 and describe what roles with what requirements exist in the project 105. The project positions 115 may be described by fields like position type, category, time demand, description, qualification requirements, etc. One example for such a position is the project manager. The qualification requirements for this position might be: account expert, at least two similar projects done, available from September until November for at least 80% of the time. Project positions 115 are non-hierarchical and can be represented by a linear list assigned to a project header. It might be necessary to change the project positions 115 continually during the life cycle of the project 105.

The resources 120 describe a particular person or group that may fill a project position. For a company project 105, the resources 120 may be all the employees of the company. The resources 120 are listed by name and may also include job title, availability, qualifications or other information. The resources 120 may also include any other personnel the company may use, including contractors and temporary workers.

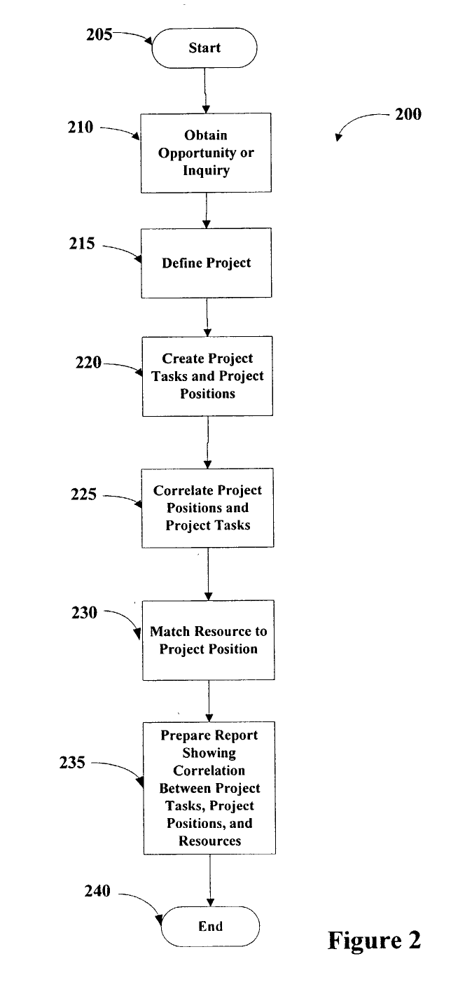

FIG. 2 illustrates a process 200 for generating a project in a project management system. The process 200 begins at a START block 205. Proceeding to block 210, an opportunity of inquiry is obtained. An opportunity or inquiry asks for a simple or complex engagement, where one or more persons are required to perform dedicated tasks. This engagement is requested to be performed in a defined time frame.

Proceeding to block 215, the process 200 defines a project 105 based on the opportunity or inquiry. The project 105 may be defined to check whether it is possible and reasonable to make an offer (quotation).

Proceeding to block 220, the requirements and tasks of the project 105 may be structured as project tasks 110 and the positions (roles) have to be estimated and structured as project positions 115. As described above, the project tasks 110 define activities and phases to be performed in the project 105 and the project positions 115 define project roles by job title.

Proceeding to block 225, the project positions 115 and the project tasks 110 are correlated. Within the project 105 a correlation between project positions 115 and project tasks 110 is performed by the project manager or a resource manager. The correlation describes what project position (role) 115 is responsible to work on a project task 110. It is possible to correlate one project position 115 to several project tasks 110. During the correlation of a project position 115 to a project task 110, the project position 115 acts as a supplier or (nominal) resource that fulfills the time demand and qualification requirements of the project task 110. Thus a matching of time and qualification data between project positions 115 and project tasks 110 should be possible.

Proceeding to block 230, the process 200 matches resources 120 to project positions 115. The program manager selects a resource 120 from all the available, qualified resources.

Proceeding to block 235, the process 200 may prepare optional reports. An integrated reporting functionality is available within the project 105. The reporting functionality may show all project tasks 110 and resources 120 for a project position 115, all project positions 115 and resources 120 that are assigned to a project task 110, and all project positions 115 and project tasks 110 that are assigned to a resource 120.

The process 200 can be accomplished by a consulting manager or by a (potential) project manager using software on a computer. The project 105 does not have to be highly complex or lengthy. For example, in a case of a so-called spot-consulting scenario (example: a consultant is needed for two days to define a report) the consulting project consists only of one position and the single task is represented by the consulting project itself.

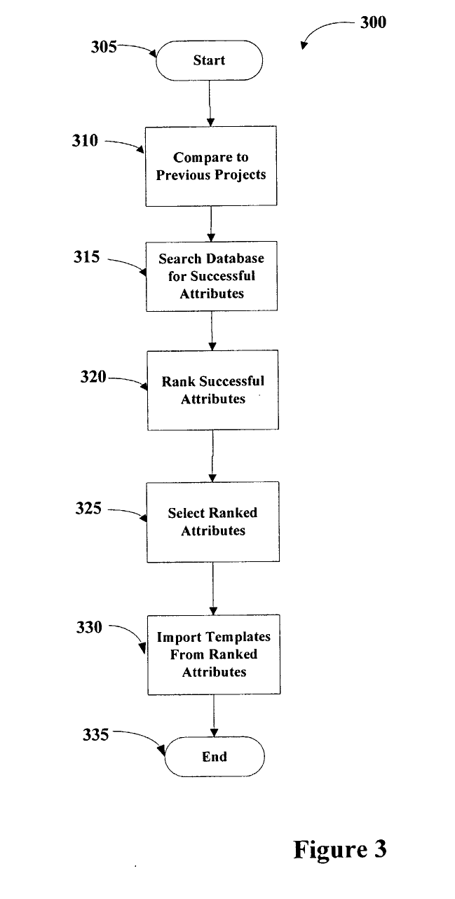

FIG. 3 illustrates a process 300 for incorporating successful project attributes in a project management system. The process 300 begins in a START block 305. Proceeding to block 310, the project manager compares the current project to previous projects. The project manager reviews how similar projects have been handled in the past, with the goal of being able to re-use presentations, written contracts, or other documents for the new project. Thus, the project manager can repeat successful methods and avoid mistakes from the past. When comparing the current project 105, the project manager may also compare individual project tasks 110, project positions 115, and even resources 120. It is possible that unrelated projects may have some similar project tasks 110 and project positions 115.

Proceeding to block 315, the project manager may search a database of previous project for successful attributes. This search may be done manually by the project manager, or may be an automated part of the project creation process. Search methods may include full text retrieval on attached documents, keyword searches, and attribute searches (e.g. industry codes, to find projects from the same industry as the client, or customer names, to find projects from the clients competitors).

Proceeding to block 320, the process ranks the successful attributes discovered during the search. The search methods may include analytical information, allowing a comparison between attributes and an ability to rank which attribute was the most successful.

Proceeding to block 325, the process selects from the ranked attributes the ones most related to the current project. This enables the project manager to perform more accurate quotations (e.g. by comparing similar projects from the past), and identify and re-apply success factors for highly profitable projects from the past.

Proceeding to block 330, the process 300 may import templates from the selected attributes. The templates allow the project manager to re-use project attributes) that have proven to be successful in the past without having to recreate the information. The project manager may copy the templates and modify them to fit them to the new project. Thus the project manager can do more realistic project plans and come to more precise quotations. The process 300 then terminates in END block 335.

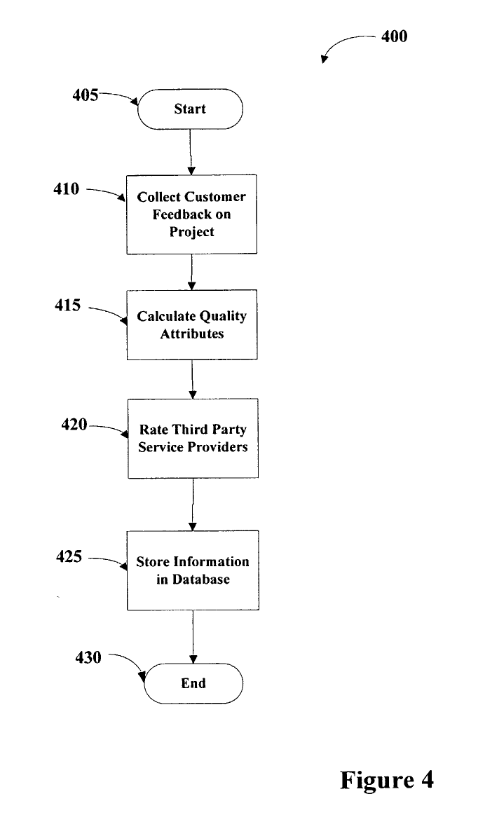

FIG. 4 illustrates a process 400 for collecting and storing effectiveness data in a project management system. The process 400 begins at a START block 405. Proceeding to block 410, customer feedback is collected on a project. The customer feedback may be continually collected during the project, and ideally after some other period (such as 6 months) following completion of the project. The feedback may be collected by customer care calling the client and requesting feedback on the project, feedback questionnaires, and any other technique used to measure customer satisfaction. The feedback results may be stored together with the project and can be used for project retrieval (e.g. search the projects with the highest client satisfaction). The feedback results may include both qualitative and quantitative data.

Proceeding to block 415, the process the calculates the quality of each of the project attributes. The quality attributes of the project are either automatically calculated or manually maintained by the engagement manager or quality manager (e.g. duration, timeliness, costs within budget, profitability). These key figures can be used for reporting or retrieval (find the most or least profitable projects, etc.).

Proceeding to block 420, the process 400 rates partner companies/sub-contractors/external consultants or other third party service providers. During or after the engagement, the service procurement manager, engagement manager or quality manager may store quality data for third party service providers involved in the system. This information can be used in later projects to find the best partners and assure the highest possible project quality.

Proceeding to block 425, the customer feedback, quality attributes, third party information, and any other project data measurement is stored in a central database accessible by other project managers. The database may be used to search for effective techniques used in the project to reuse in later projects. The process 400 then terminates in END block 430.

Numerous variations and modifications of the invention will become readily apparent to those skilled in the art. Accordingly, the invention may be embodied in other specific forms without departing from its spirit or essential characteristics.

What is claimed is:

1. A method of project knowledge management comprising:
defining one or more project attributes of a current project;
searching for similar attributes from a database of rated attributes from previous projects;
selecting one or more of the similar attributes; and
importing data from the selected attribute into the current project.

2. The method of claim 1, further comprising ranking one or more similar attributes based on the ratings.

3. The method of claim 1, further comprising importing templates of the selected attributes.

4. The method of claim 2, further comprising ranking the attributes based on customer feedback.

5. The method of claim 2, further comprising ranking the attributes based on quality measurements.

6. The method of claim 2, further comprising including third party service provider information in the attribute rankings.

7. An article comprising:
a storage medium having stored thereon instructions that when executed by a machine results in the following: defining one or more project attributes of a current project;
search for similar attributes from a database of rated attributes from previous projects;
select one or more of the similar attributes; and
import data from the selected attribute into the current project.

8. The article of claim 7, wherein one or more similar attributes are ranked based on the ratings.

9. The article of claim 7, wherein templates of the selected attributes are imported.

10. The article of claim 8, wherein the attributes are ranked based on customer feedback.

11. The article of claim 8, wherein the attributes are ranked based on quality measurements.

12. The article of claim 8, wherein third party service provider information is included in the attribute rankings.

13. A method of project knowledge management comprising:
defining one or more project attributes of a current project;
collecting feedback data on the one or more project attributes;
calculating quality attributes for the one or more project attributes; and
saving the feedback and quality attribute data in a searchable database.

14. The method of claim 13, further comprising rating third party service providers of the one or more project attributes.

15. The method of claim 13, further comprising;
searching the database for attributes similar to a current project;
selecting one or more of the similar attributes; and
importing data from the selected attribute into the current project.
